(19) United States
(12) Patent Application Publication
(10) Pub. No.: US 2024/0382786 A1
(43) Pub. Date: Nov. 21, 2024

(54) PUMP GUARD WITH AIR DEFLECTOR AND FIRE PROTECTION, AND METHODS OF USE

(71) Applicant: Thomas Wechsler, Snellville, GA (US)

(72) Inventor: Thomas Wechsler, Snellville, GA (US)

(21) Appl. No.: 18/666,111

(22) Filed: May 16, 2024

Related U.S. Application Data
(60) Provisional application No. 63/502,568, filed on May 16, 2023.

(51) Int. Cl. A62C 3/00

(52) U.S. Cl. CPC A62C 3/00

(57) ABSTRACT

A pump guard with air deflector, fire protection, to provide an inner housing or guard configured to cover the mechanical seal assembly, the motor coupling, mechanical seals, and part of bearing housing between a drive motor and a fluid pump, where the inner housing or guard includes an extended guards to extend coverage of the inner housing or guard around the fluid pump side of the coupling, the addition of directional deflector configured to focus an air stream directly on the bearing/seal assembly itself, and an outer “Air scoop” housing or guard configured to direct motor induced airflow over the mechanical seal assembly and into directional deflector.

### CROSS-REFERENCE TO RELATED APPLICATIONS

To the full extent permitted by law, the present United States Non-Provisional patent application hereby claims priority to and the full benefit of United States Provisional Application entitled “ADVANCED PUMP SEAL COOLING AND FIRE PROTECTION APPARATUS AND METHODS OF USE THEREOF,” having assigned Ser. No. 63/502,568, filed on May 16, 2023, incorporated herein by reference in its entirety.

### FIELD OF THE DISCLOSURE

This disclosure relates to a pump guard and methods of use thereof. More specifically the disclosure relates to a fire protection shield for a mechanical seal assembly and coupler between a drive motor and fluid pump.

### BACKGROUND

Fluid pumps are utilized in a variety of industries to move fluids and to pressurize fluids. Some pump system require pump protection systems, for example, when involving the operation of pumps handling flammable fluids, such as a pump for an organic flammable liquid with mechanical seals. These pumps are generally operating at elevated temperatures, where leakages of fluid around the pump mechanical seal area, which is common, may provide a source of fire. Seal degradation and failure is accelerated by high temperatures, which organic fluids are commonly operated at, leading to a seal failure, which in turn may lead to a source of fire or an actual fire. This fire once started at the pump may spread to other parts of the plant, and is one of the most common fire hazards associated with this type of pump operation.

One disadvantage is that the manufactures of the individual components of a fluid pump system, such as the mechanical seal assembly, coupler, motor and fluid pump are often manufactured separately and therefore the above fire protection issues have generally not been addressed by the component manufacture. Make shift solutions have been used generally by either pump skid integrators or more common by users/operators themselves.

One approach includes attempts to improve cooling of mechanical seals in order to increase their longevity have generally included modifying or replacing coupling guards to direct motor air to flow over the pump seal thereby cooling it. Coupling guards are generally a metal shield whose function is to protect users from accessing the rotating coupling and shaft connecting motor and pump. While these modifications to the coupling guard may have provided the desired cooling effect, one disadvantage to this approach is abundant air flow to fan a fire, and should the seal begin to leak, thereby promoting the fire, and aiding in its spread.

Another approach to mitigate pump fires has been to place heat, smoke, and fire sensing equipment and water sprays or fire suppressing foam spray delivery systems proximate the pump seal area which automatically discharge in the event of a sensed fire. Some systems have been observed by which the foam spray nozzles have been directly inserted into the coupling guard housings which may be more effective than the more generalized nozzle placement. These fire mitigation systems have been limited in effectiveness as the area to be covered for fire protection is not limited, and these nozzles alone positioned proximate the mechanical seal do not provide a system to contain the spread of fire. These fire suppression systems have addressed the fire once it breaks out; none have addressed the cooling and longevity of the seals themselves to help prevent leakage.

Moreover, none of the above systems as described have been observed to be commercially available. Further, none have addressed the simultaneous needs to address air cooling needed to extend seal life and to protect mechanical seals from pre-mature failure, due to heating, while additionally mitigating its effect to fan the fire, and once failed to prevent fluid spread, a fire from igniting the discharging flammable liquid, suppress any fire which may have started and the spread of fire beyond the mechanical seal.

Currently pump protection systems are not designed to protect mechanical seals from pre-mature failure, due to heating or misalignment, and, once failed to prevent a fire from the discharging flammable liquid or its spread. These issues have not generally been addressed by the pump manufacturer. Make shift solutions have been used generally by either pump skid integrators or more common by users themselves. Commercially available systems have limited fire suppression either to a general area outside the pump, not addressing the pump seal directly, or have address specifically the seal area itself, not covering any areas beyond the seal itself.

Therefore, it is readily apparent that there is a recognizable unmet need for pump guard with air deflector, fire protection, and methods of use that may be configured to address at least some aspects of the problems discussed above. Moreover, a pump guard and methods of use thereof that functions to enable a combination of features including address the simultaneous needs to address air cooling to extend seal life and to protect mechanical seals from pre-mature failure, due to heating, while additionally mitigating the cooling air flow effect to fan the fire, and once failed to prevent fluid spread, a fire from igniting the discharging flammable liquid, and suppress any fire which may have started and the spread of fire beyond the mechanical seal.

### SUMMARY

Briefly described, in an example embodiment, the present disclosure may overcome the above-mentioned disadvantages and may meet the recognized need for pump guard with air deflector, fire protection, and methods of use to provide an apparatus that generally includes an inner housing or guard configured to cover the mechanical seal assembly, i.e. the motor coupling, mechanical seals, and part of bearing housing between a drive motor and a fluid pump, where the inner housing or guard includes an extended guard to extend coverage of the inner housing or guard around the fluid pump side of the coupling, the addition of directional deflector configured to focus an air stream directly on the bearing/seal assembly itself, and an outer “Air scoop” housing or guard configured to direct motor induced airflow over the mechanical seal assembly and into directional deflector.

Accordingly, in one aspect, the present disclosure generally includes an inner housing or guard configured to the cover mechanical seal assembly and the motor coupling housed between a drive motor and a fluid pump to enable foam spray nozzles to be directly inserted into the guard housings for fire suppression containment zone and an outer “Air scoop” housing or guard configured to direct motor induced airflow over the mechanical seal assembly and through directional deflector, thereby cooling it to extend seal life and to protect mechanical seals from pre-mature failure.

Accordingly, in another aspect, the present disclosure generally, includes a combination shield or guard such as an inner housing with an extended guard fitted around mechanical seal assembly, as well as a directional air deflector or air scoop to direct and feed cooling air flow directly on the high heat source mechanical seal assembly and bearing to protect the mechanical seals, bearing seals, pump seals, and bearing from pre-mature failure.

In an exemplary embodiment of a shroud of a motor that generates a cooling airflow, a motor shaft, a motor-pump coupler, a mechanical seal assembly, a pump shaft, and a pump, having an outer housing configured as an air scoop having a first zone to direct cooling air from the motor over the pump mechanical seal assembly, the outer housing formed of a first outer housing side wall and a second outer housing side wall, and a first arching top connected thereto the first outer housing side wall and the second outer housing side wall, and an inner housing positioned within the outer housing and configured to seal a second zone therearound the motor shaft proximate the motor, the motor-pump coupler, and the mechanical seal assembly, the inner housing formed of a first arching section and a second arching section removably affixed together, the first arching section having first upper end equipment seal to form an upper seal around the mechanical seal assembly of the pump and a second upper end equipment seal to form an upper seal around the motor shaft proximate the motor, the second arching section having first lower end equipment seal to form a lower seal around the mechanical seal assembly of the pump and a second lower end equipment seal to form a lower seal around the motor shaft proximate the motor.

A feature of the present disclosure pump protection systems, involving operation of pumps handling an organic flammable liquid with mechanical seals, generally operating at elevated temperatures, where leakages of fluid around the pump mechanical seal and bearings area, which are common, may provide a source a source of fire. Seal degradation and failure is accelerated by high temperatures, which organic fluids are commonly operated at, leading to a seal failure, which in turn may lead to a fire. In addition, slow leaks may have caused a buildup of flammable material on the bearing and seal housing itself, which, should a seal fire occur, will propagate the fire to beyond the seal area, outside of the typical guard housings. These fires, once started here, may spread to other parts of the plant, and is one of the most common fire hazards associated with this type of pump operation.

A feature of the present disclosure is to provide fire suppression system proximate a high heat source mechanical seals, bearing, and coupler and seal off such area around the motor pump coupling with an inner housing or guard configured to the cover part of mechanical seal assembly with an extended guard and provide fire suppression nozzles therein the housing or guard directed at the mechanical seal assembly.

Another feature of the present disclosure is the ability to provide an inner housing to cover the rotating units of the pump-motor coupling and extend forward with a fitted mechanical seal assembly cover section to enclose the front part of the bearing seal under the inner housing, such that it is isolated from air flows, and durable enough to contain a fire that may emanate from the pump seal, bearing seal, coupler, or mechanical seal assembly.

Yet another feature is the ability of the inner housing to extend forward with a fitted mechanical seal assembly cover section to enclose the front part of the bearing seal under the inner housing sufficiently to not only capture dripping leaked fluid, but also capture and contain any leaked fluid which may be slung outward by the rotating action of the shaft.

Yet another feature of the present disclosure is its ability to provide cooling air flow over the inner housing and mechanical seal assembly and into the directional air deflector or air scoop to direct and feed cooling air flow directly on the high heat source mechanical seal assembly and bearing to protect the mechanical seals, bearing seals, pump seals, and bearing from pre-mature failure.

Yet another feature of the present disclosure is the ability to contain or position therein the inner housing, cover, or guard with any fire suppression nozzles and dedicated foam suppression for each pump, should they be used.

Yet another feature of the present disclosure is the ability to configure the inner housing, cover, or guard of a flame and heat resistant material such that it could limit a fire's spread.

Yet another feature of the present disclosure is the ability to position therein the inner housing, cover, or guard fire suppression nozzles and fire sensing lines or other apparatus to extinguish a fire.

Yet another feature of the present disclosure is the ability to provide fire suppressant via the nozzles, such as water or foam based or may use other fire suppressing fluids or substances.

Yet another feature of the present disclosure is the ability to contain foam or other extinguishing agent in the inner housing.

Yet another feature of the present disclosure is the ability to provide catch or drip trays, liners or edging constructed to collect spray and drips from leaks of pump mechanical seal and/or foam fire agents to limit spread of fires.

Yet another feature of the present disclosure is the ability to provide a confined inner space in which any fire may be contained, should it be initiated by a mechanical seal leak.

Yet another feature of the present disclosure is the ability to provide a confined inner space in which air flow may be restricted, should a fire be initiated by a mechanical seal leak.

Yet another feature of the present disclosure is its ability to increase the cooling air velocity and thereby its effectiveness using a converging section in the directional air deflector.

Yet another feature of the present disclosure is the ability to provide an outer air scoop housing, cover, or guard configured to surround the inner housing and direct air flow to cool the high heat source mechanical seal assembly and bearing.

Yet another feature of the present disclosure is the ability to provide an outer air scoop housing, cover, or guard configured to capture cooling air from the motor fan, or any other fan, and to direct the airflow over the inner housing toward the pump seal or mechanical seal assembly additionally via the directional air deflector to provide the desired cooling effect for the pump seal or mechanical seal assembly.

Yet another feature of the present disclosure is the ability to provide cooling air flow from motor or forced cooling air from other sources such as fans, compressors, etc.

Yet another feature of the present disclosure is the ability to provide an outer air scoop housing, cover, or guard configured to provide airflow cooling for instrumentation used to monitor the pump seal conditions, such as vibration sensors or other instrumentation which may be placed on or near pump seals or mechanical seal assembly and exposed to high temperatures around the pump seal area. These instruments may be for preventive purposes to monitor pump and/or seal conditions before the pump and/or seal progress to an unstable state.

Yet another feature of the present disclosure is the ability to provide an inner and outer housing, cover, or guard configured to isolate the cooling air flow from the pump seal area so as not to feed air to or fanning a fire, while still providing protective functions of an inner housing that limit access to rotating components and prevent spread of any fires outside the inner housing originating at the pump mechanical seal area where a leak or fire may occur.

Yet another feature of the present disclosure is the ability to provide inner and outer housing, cover, or guard configured to fit, placed over, or positioned on any conventional pump-motor arrangement and fitted to new or existing pump-motor systems.

These and other features of the pump guard with air deflector, fire protection, and methods of use and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure for a pump guard with air deflector, fire protection, and methods of use and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1A is a left side perspective view of an exemplary embodiment of the pump guard fitted to a motor-pump assembly junction according to select embodiments of the disclosure;

FIG. 1B is a right side perspective view of an exemplary embodiment of the pump guard fitted to a motor-pump assembly junction according to select embodiments of the disclosure;

FIG. 1C is a side view of an exemplary embodiment of the pump guard fitted to a motor-pump assembly junction, shown with the outer housing hinged open to showing the motor-pump coupler according to select embodiments of the disclosure;

FIG. 2A is a front perspective view of an exemplary embodiment of the inner housing of the pump guard and methods of use, according to select embodiments of the disclosure in FIG. 1C;

FIG. 2B is a side view of an exemplary embodiment of the inner housing of the pump guard and methods of use, according to select embodiments of the disclosure in FIG. 2A;

FIG. 2C is an end perspective view of an exemplary embodiment of the inner housing of the pump guard and methods of use, according to select embodiments of the disclosure in FIG. 2A;

FIG. 3A is a perspective front view of an exemplary embodiment of the outer housing of the pump guard and methods of use, according to select embodiments of the disclosure in FIG. 1;

FIG. 3B is a first side view of an exemplary embodiment of the outer housing of the pump guard and methods of use, according to select embodiments of the disclosure in FIG. 3A;

FIG. 3C is a second side view of an exemplary embodiment of the outer housing of the pump guard and methods of use, according to select embodiments of the disclosure in FIG. 3A;

FIG. 3D is a perspective rear view of an exemplary embodiment of the outer housing of the pump guard and methods of use, according to select embodiments of the disclosure in FIG. 3A; and

FIG. 4 is a flow diagram of a method of isolating via an inner housing and cooling with an outer housing filtering of the pump guard and methods of use, according to select embodiments of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures, specific terminology is employed for clarity. The present disclosure, however, is not intended to be limited to the specific terminology selected; it is to be understood that each specific element includes all technical equivalents that operate in a similar manner to accomplish similar functions. Embodiments of the claims may, however, be embodied in many different forms and should not be construed as limited to the embodiments set forth herein. The examples set forth herein are non-limiting examples, and are merely examples among other possible examples. It is recognized herein that the optimum dimensional relationships, to include variations in size, materials, shape, form, position, connection, function and manner of operation, assembly and use, are intended to be encompassed by the present disclosure.

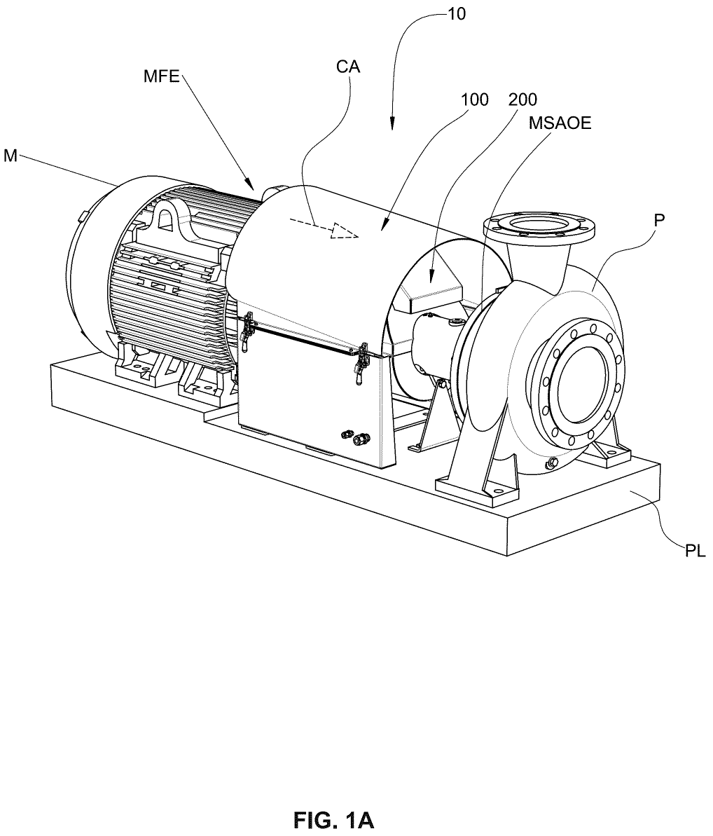

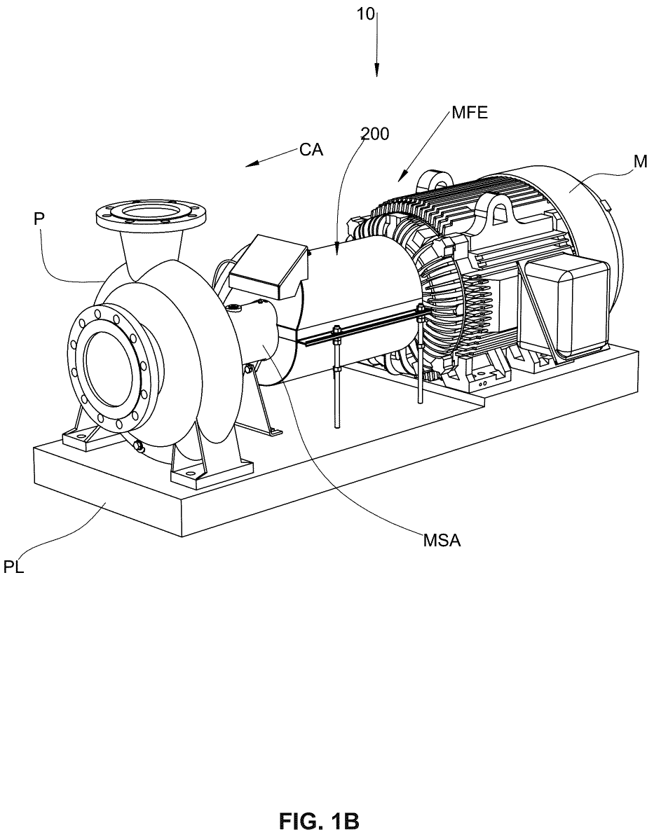

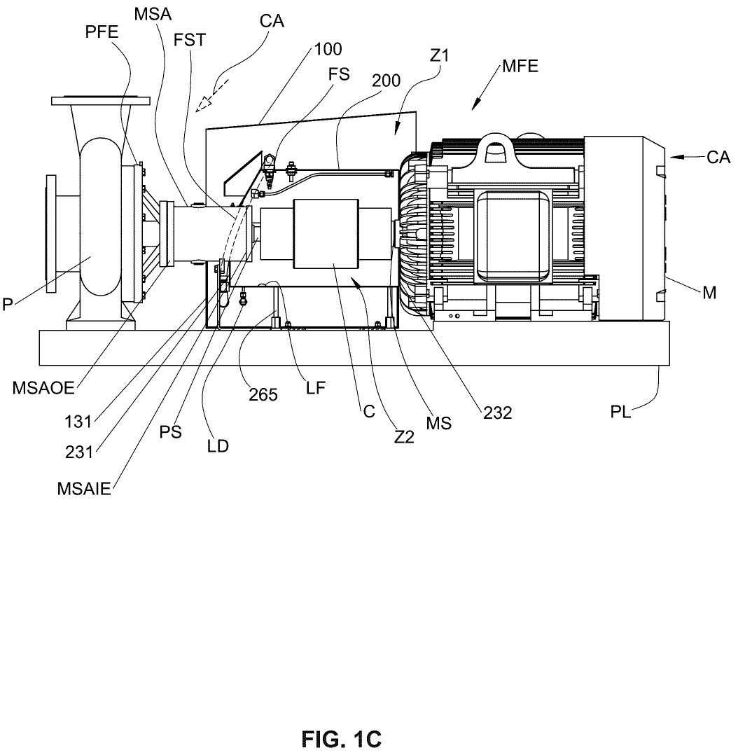

Referring now to FIGS. 1A, 1B, and 1C, by way of example, and not limitation, there is illustrated an example embodiment combination housing, cover, shroud, or guard device, such as pump guard 10. Pump guard 10 may be configured of two or more housing, cover, guard, shroud, or isolation zone, such as outer housing, encase, cover, guard, or isolation zone (outer housing) 100 and inner housing, cover, guard, shroud, or isolation zone (inner housing) 200. Both outer housing 100 and inner housing 200 may be positioned to substantially cover, encase, and/or seal pump rotating parts and shaft seal area, such as motor-pump coupler C and pump mechanical seal assembly MSA positioned and mechanically connected therebetween motor M and fluid pump P, and all positioned or resting thereon platform PL. A mechanical seal is an apparatus utilized to contain fluid, within a vessel, such as pumps (especially pumps handling flammable fluids), mixers, or the like where a rotating shaft passes through a stationary housing. A coupler is a mechanical apparatus utilized to connect two rotating shafts together.

Referring again to FIGS. 1A, 1B, and 1C, and more specifically FIG. 1A shows a left side perspective view of pump guard 10 configured with outer housing 100 in a closed or sealed position to cover, shroud, seal therearound, or isolate an area, such as first zone Z1 between approximately motor front edge MFE and extend to mechanical seal assembly outer edge MSAOE and down to platform PL. It is contemplated herein that outer housing 100 may be slanted due to height difference between motor front edge MFE and mechanical seal assembly outer edge MSAOE and extend thereto pump front edge PFE. The outer housing 100 may be slanted as well to direct airflow to aid in cooling rotating unit. Preferably, outer housing 100, air deflector, and first zone Z1 are configured to capture cooling airflow CA from the motor fan, or any other fan, and to direct the airflow of cooling airflow CA over the inner housing and directed thereon mechanical seal assembly MSA, pump front edge PFE, and/or pump P to provide the desired cooling effect for the mechanical seal assembly MSA to extend mechanical seal assembly MSA life and to protect mechanical seal assembly MSA from pre-mature failure. Moreover, to provide the desired cooling effect for the pump front edge PFE, and/or pump P to extend pump front edge PFE and/or pump P life and to protect pump front edge PFE and/or pump P from pre-mature failure. It is contemplated herein that outer housing 100 may be configured or sized to fit any variety of motor M and fluid pump P sizes and configurations.

Referring again to FIGS. 1A, 1B, and 1C, and more specifically FIG. 1B which shows an alternate perspective view of pump guard 10 configured with outer housing 100 in an open, removed or unsealed position exposing inner housing 200 thereunder outer housing 100. Preferably inner housing 200 may be configured in a closed or sealed position to cover, seal therearound, shroud, or isolate an area, such as second zone Z2 between approximately motor front edge MFE or motor shaft MS, over mechanical seal assembly inner edge MSAIE, covering the first part of mechanical seal assembly MSA, and therearound coupler C, motor shaft MS, and pump shaft PS, preferably a foam seal zone. It is recognized herein that inner housing 200 may substantially cover, encase, and/or seal motor-pump rotating parts and shaft seal area. It is contemplated herein that inner housing 200 may extend to cover mechanical seal assembly MSA and thereto pump front edge PFE if need be. Preferably, inner housing 200 and second zone Z2 are configured to isolate rotating units of the pump-motor coupling, mechanical seal assembly MSA to limit access to rotating components and prevent spread of any fires from the mechanical seal MSA area where a leak or fire may occur. It is further contemplated herein that inner housing 200 and second zone Z2 may extend thereto pump front edge PFE to prevent spread of any fires from pump front edge PFE area where a leak or fire may occur. It is further contemplated herein that inner housing 200 may be configured or sized to fit any variety of motor M, motor-pump coupler C, pump P, mechanical seal assembly MSA sizes and configurations. It is still further contemplated herein that inner housing 200 and second zone Z2 may be configured to enable leak detection equipment LD therein second zone Z2.

Furthermore, inner housing 200 may include directional air deflector 500 positioned proximate a front edge 233 (front or first upper end equipment seal 231A) of inner housing 200 to direct the airflow captured by outer housing 100 thereon mechanical seal assembly MSA, to provide improved cooling effect for the mechanical seal assembly MSA to extend mechanical seal assembly MSA life and to protect mechanical seal assembly MSA from pre-mature failure.

It is contemplated herein that fire protection, suppressing, and sensing equipment FS may include pumps, piping, tubing, nozzles, and the like to sense or detect leaks, smoke, fire, heat therein inner housing 200 and/or second zone Z2 and deliver fire suppressant, such as foam or other extinguishing agents into inner housing 200 and/or second zone Z2.

It is recognized herein that inner housing 200 may be configured or designed to limit ingress of cooling airflow CA into second zone Z2 to prevent fanning of a fire where a leak induced fire is likely to occur.

Referring again to FIG. 1C which shows a cross-sectional view of the outer housing 100 and inner housing 200 to show motor M, fluid pump P, motor-pump coupler C, pump mechanical seal assembly MSA, thereunder, second zone Z2 and first zone Z1, respectively. Inner housing 200 and/or second zone Z2 may include fire protection, suppressing, flame suppressant, and sensing equipment FS to detect, extinguish and prevent spread of any fires and contain any leak therein second zone Z2 (fire protection and containment zone). It is contemplated herein that inner housing 200 and/or second zone Z2 may include a lip or front cover, such as equipment air seal 230 configured to seal therearound mechanical seal assembly MSA, coupler C, pump shaft PS, and motor shaft MS. Outer housing 100 and/or first zone Z1 may be configured as an “air scoop” to direct forced air, such as cooling airflow CA from or through motor M, therethrough directional air deflector 500 and directed thereon pump mechanical seal assembly MSA to provide cooling air flow over mechanical seal assembly MSA therein first zone Z1 (air cooling zone). It is contemplated herein that forced air, such as cooling airflow CA may be from other or an alternate forced air sources. It is further contemplated herein that outer housing 100 and/or first zone Z1 may be extended further to cool other pump parts such as rear housing RH, pump front edge PFE if desired.

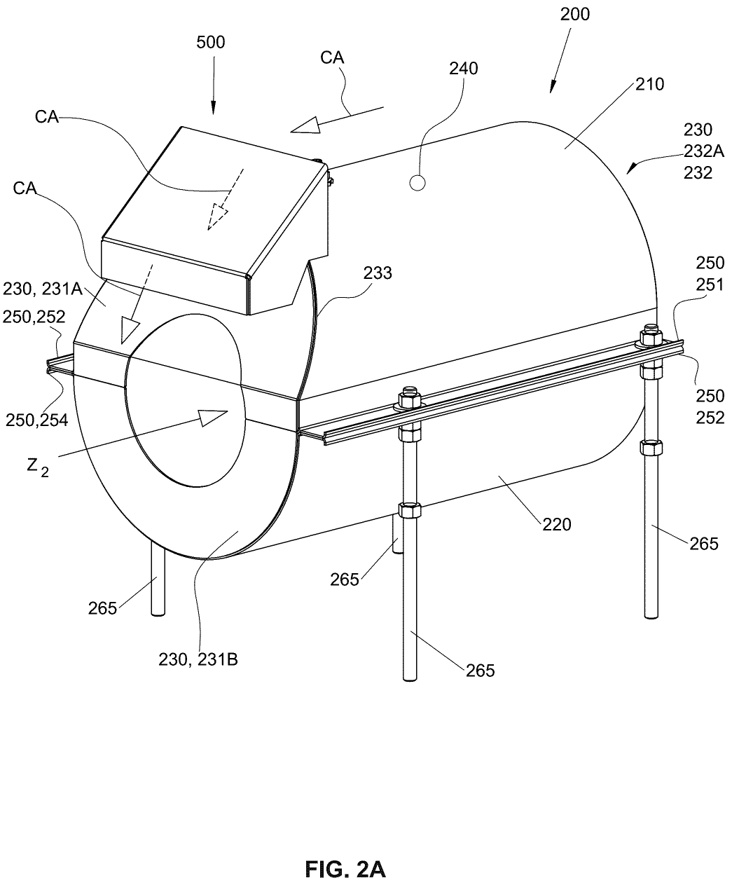

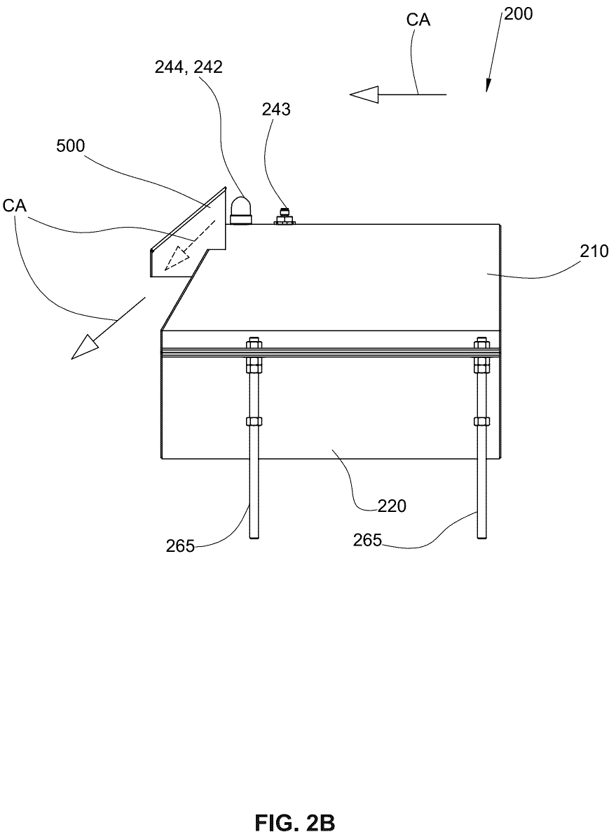

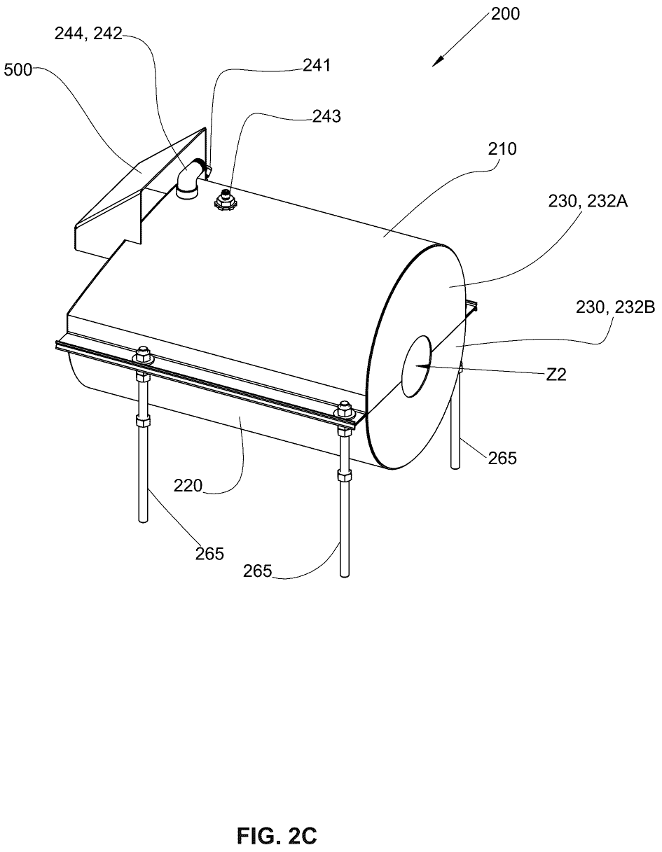

Referring now to FIGS. 2A, 2B, 2C, and 2D by way of example, and not limitation, there is illustrated an example embodiment of housing, cover, cowling, guard, shroud, or isolation zone, such as inner housing 200. Inner housing 200 may include one or more side walls or panels or cylindrical sections, such as first arching section 210 and second arching section 220 removably affixed or fitted together to form inner housing 200, preferably configured as a barrel. First arching section 210 and second arching section 220 may include one or more edge contours, shapes, or cutouts, configured to accommodate contour differences between motor M, pump mechanical seal MSA, and pump P differences in dimensions, sizes, and configurations shown in FIG. 1 for the purpose of sealing second zone Z2 and to isolate rotating units of the motor M, pump-motor coupling, coupler C, mechanical seal assembly MSA, and/or pump P to limit access to rotating components and prevent spread of any fires from second zone Z2 and more specifically mechanical seal assembly MSA where a leak or fire may likely occur.

Moreover, first arching section 210 and second arching section 220 may include one or more end, or front and back lip, flap, flange, baffle, separator or similar airflow or sealing device, such as one or more end equipment seals 230. End equipment seals 230 may include front or first upper end equipment seal 231A to form an upper seal around an upper section of mechanical seal assembly MSA of the pump P and rear or second upper end equipment seal 232A to form an upper seal around an upper section of the motor shaft MS or motor front edge MFE, each affixed to an end of first arching section 210 to further limit ingress of cooling airflow CA into sealed area second zone Z2 and to contain fire suppression foam. End equipment seals 230 may include front or first lower end equipment seal 231B to form a lower seal around a lower section of mechanical seal assembly MSA of the pump P and rear or second lower end equipment seal 232B to form a lower seal around a lower section of the motor shaft MS or motor front edge MFE, each affixed to an end of second arching section 220 to further limit ingress of cooling airflow CA into sealed area second zone Z2 and to contain fire suppression foam.

Furthermore, front or first upper end equipment seal 231A and front or first lower end equipment seal 231B together may be configured to seal therearound mechanical seal assembly MSA to further limit ingress of cooling airflow CA into sealed area second zone Z2 and to contain fire suppression foam. Still furthermore, rear or second upper end equipment seal 232A and rear or second lower end equipment seal 232B together may be configured to seal therearound motor shaft MS or motor front end MFE to further limit ingress of cooling airflow C into sealed area second zone Z2 and to contain fire suppression foam.

It is contemplated herein that equipment seals 231 may be configured or shaped to mate therewith coupler C, mechanical seal assembly MSA, pump shaft, mechanical seal assembly inner edge MSAIE, and/or front face of pump P (shown in FIG. 1C). Furthermore, equipment air seal 232 may be configured to seal therearound motor shaft MS, motor front end MFE, or motor M as motor side air seal, (shown in FIG. 1C). It is contemplated herein that second zone Z2 of inner housing 200 provides a limited volume confined space to improve effectiveness of fire suppression. The isolation of cooling air outside of second zone Z2 prevents further spreading or re-ignition. It is further contemplated herein that second zone Z2 of inner housing 200, which is used to contain drips of leaks therein to prevent drip spread and thereby limit spread of any potential liquid or in the event of fire, spread of fire. Further, the containment area second zone Z2 of inner housing 200 serves to limit the spread of flame suppressing agent which may be in liquid form.

It is contemplated herein that to seal second zone Z2 of inner housing 200, first arching section 210 and second arching section 220, equipment air seal 230, 231, 232 may be bent, formed or shaped or otherwise configured to accommodate and seal coupler C, mechanical seal assembly MSA, motor or pump shaft, mechanical seal assembly inner edge MSAIE, and/or front face of pump P.

Inner housing 200 substantially covers pump bearing and seal area beyond the shaft seal area.

Furthermore, first arching section 210 and second arching section 220 may include one or more holes therethrough, such as outer housing aperture 240 and be equipped with fire protection, suppression, and sensing equipment FS and include a fire suppression agent system/nozzle arrangement and sensing line to provide fire suppression capability therein inner housing 200, should a fire start in this area.

Still furthermore, first arching section 210 and second arching section 220 may be supported above platform PL by vertical supports 265 to ensure a tight seal of second zone Z2 and inner housing 200 therearound coupler C, mechanical seal assembly MSA, motor or pump shaft, mechanical seal assembly inner edge MSAIE, and/or front face of pump P. Alternatively, first arching section 210 and second arching section 220 may be supported by attachment to mechanical seal assembly MSA and motor M.

Still furthermore, first arching section 210 and second arching section 220 may include a horizontal lip, such as edge flange 250 and more specifically first edge flange 251 and second edge flange 252 making up each edge of first arching section 210, respectively and third edge flange 253 and fourth edge flange 254 making up each edge of second arching section 220. It is contemplated that the two half shells of first arching section 210 and second arching section 220 may be joined together via edge flanges 250 using attachment device, such as screws, nuts and bolts, or vertical supports 265 to form inner housing 200 and second zone Z2 equipment seal. Again, first arching section 210 and second arching section 220 may include edge flanges 250 to join first arching section 210 and second arching section 220.

Still furthermore, first arching section 210 and/or end equipment seals 230, 231 may include directional air deflector 500 positioned proximate first edge 233 of first arching section 210. Directional air deflector 500 may be configured to scoop, direct or capture cooling airflow CA from motor M traversing over first arching section 210 and redirect cooling airflow CA onto coupler C, mechanical seal assembly MSA, motor or pump shaft, mechanical seal assembly inner edge MSAIE, and/or front face of pump P to extend coupler C, mechanical seal assembly MSA, motor or pump shaft, mechanical seal assembly inner edge MSAIE, and/or front face of pump P life and to protect coupler C, mechanical seal assembly MSA, motor or pump shaft, mechanical seal assembly inner edge MSAIE, and/or front face of pump P from pre-mature failure by cooling these parts directly. It is contemplated herein that first arching section 210 and/or end equipment seals 230, 231 may include directional air deflector 500 may be configured as a variety of forms and shapes and conduit sections providing a conduit or passageway for cooling airflow CA therethrough.

One or more directional air deflector 500 may be utilized to take cooling airflow CA from motor M, and further direct it to flow directly over the bearing housing, mechanical seal assembly MSA, thereby “focusing” said air stream on the area to be cooled. Directional air deflector 500 may be a simple deflector to direct cooling airflow CA specifically towards the area to be cooled, or may be contain a converging section to increase air velocity over the area to be cooled, further enhancing its cooling effect. Additionally, this deflector may include connections for external forced cooling provided by fan or other air source to provide additional cooling to bearing housing, mechanical seal assembly MSA. Moreover, directional air deflector 500 may be shaped to capture cooling airflow CA from the motor M fan or air scoop, if present, and to specifically direct or “focus” cooling airflow CA over onto bearing housing, mechanical seal assembly MSA to enhance any cooling effect.

One or more directional air deflector 500 may include a plate to deflect air, may be curved to match inner housing 200 or may be a three sided enclosure (as shown) on top or around inner housing 200. Directional air deflector 500 may be enclosed, formed as a straight section or a converging section to increase air velocity of cooling airflow CA for further enhanced cooling.

Inner housing 200 may be formed of any airtight, heat resistant, and/or corrosion resistant material, capable of creating a fire sealed area and directing airflow through a designated pathway. Moreover, inner housing 200 may preferably be constructed of stainless steel, aluminum, heat resistant fiberglass, plastic, as these materials offers a variety of forms and shapes; however, other suitable materials such as metal, concrete, composite, and the like, formed of multiple layers with different materials, or the like, may be utilized, provided such material has sufficient strength and/or durability as would meet the purpose described herein.

Still furthermore inner housing 200 may include one or more edge contours, shapes, or cutouts, configured to accommodate contour differences between therearound coupler C, mechanical seal assembly MSA, motor or pump shaft, mechanical seal assembly inner edge MSAIE, and/or front face of pump P differences in dimensions, sizes, and configurations shown in FIG. 1 for the purpose of sealing second zone Z2 and to isolate rotating units of the therearound coupler C, mechanical seal assembly MSA, motor or pump shaft, mechanical seal assembly inner edge MSAIE, and/or front face of pump P to limit access to rotating components and prevent spread of any fires from second zone Z2 and more specifically mechanical seal assembly MSA where a leak or fire may likely occur.

Moreover, inner housing 200 may include one or more holes therethrough, such as apertures 240 configured as an instrument access port thereto second zone Z2, fire safety devices FS, such as fire detection device 241, fire suppression device 242, and temperature or fire sensing equipment 243, and foam injection nozzle 244. It is recognized herein that inner housing 200 may be equipped with fire safety devices FS whether fire protection, containment, suppression, and sensing equipment, such as fire detection device 241, fire suppression device 243, and temperature or fire sensing equipment 244, and foam injection nozzle 244 and include a fire suppression agent system/nozzle arrangement and sensing line to provide fire suppression capability therein inner housing 200, should a fire start in this area. It is recognized herein that fire sensing equipment 244 may include monitoring devices, such as temperature sensors, vibration sensors, or leakage detection devices configured for early detection of possible seal leaks. Fire sensing equipment 244 may be connected to a single pump monitoring system or a multiple pump monitoring system. Guard extension, such as inner housing 200 may further rely on a single foam injection nozzle 244 to cover all areas or may contain additional foam injection nozzle 244 to cover the bearing housing area, and more specifically mechanical seal assembly MSA.

Moreover, inner housing 200 may include equipment air seal 230 may include motor side equipment seal, such as equipment air seal 230, 232 configured to seal therearound motor M as motor side air seal. It is contemplated herein that second zone Z2 of inner housing 200 provides a limited volume confined space to improve effectiveness of fire suppression. The isolation of cooling air outside of second zone Z2 prevents further spreading or re-ignition. It is further contemplated herein that second zone Z2 of inner housing 200, which is used to contain drips of leaks therein to prevent drip spread and thereby limit spread of any potential liquid or in the event of fire, spread of fire. Further, the containment area second zone Z2 of inner housing 200 serves to limit the spread of flame suppressing agent which may be in liquid form.

It is contemplated herein that equipment air seal 230 and/or directional air deflector 500 may be removably affixed thereto first arching section 210 and second arching section 220.

It is contemplated herein that inner housing 200 may be utilized in the capture of leaked fluid LF that is slung by centrifugal force of rotating units thereunder, such as coupler C, mechanical seal assembly MSA, motor or pump shaft.

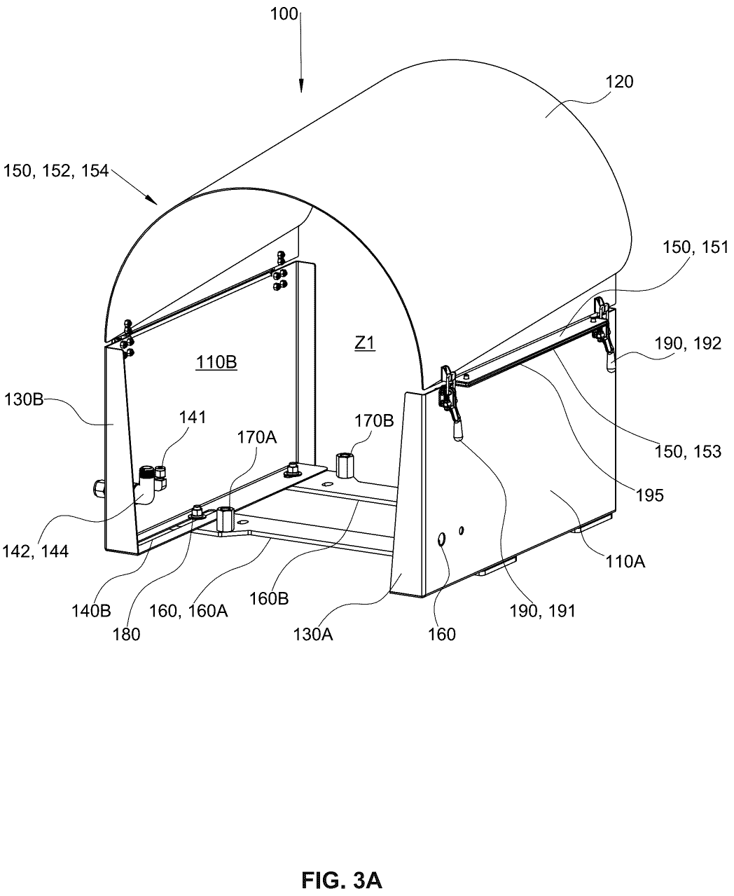

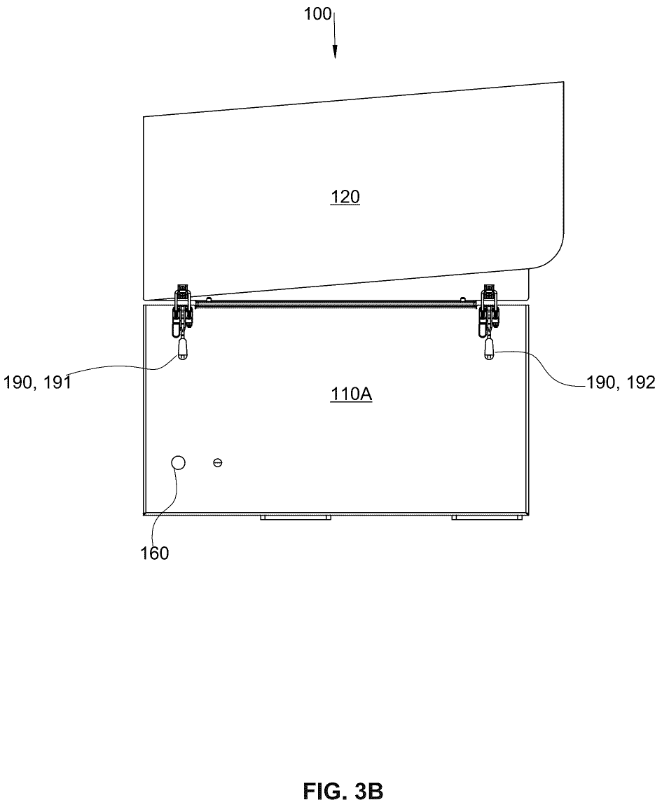

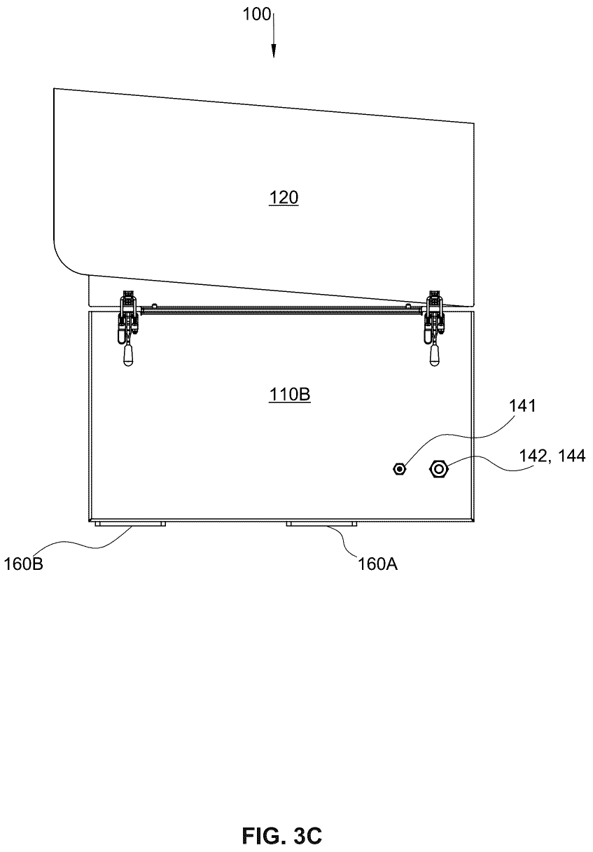

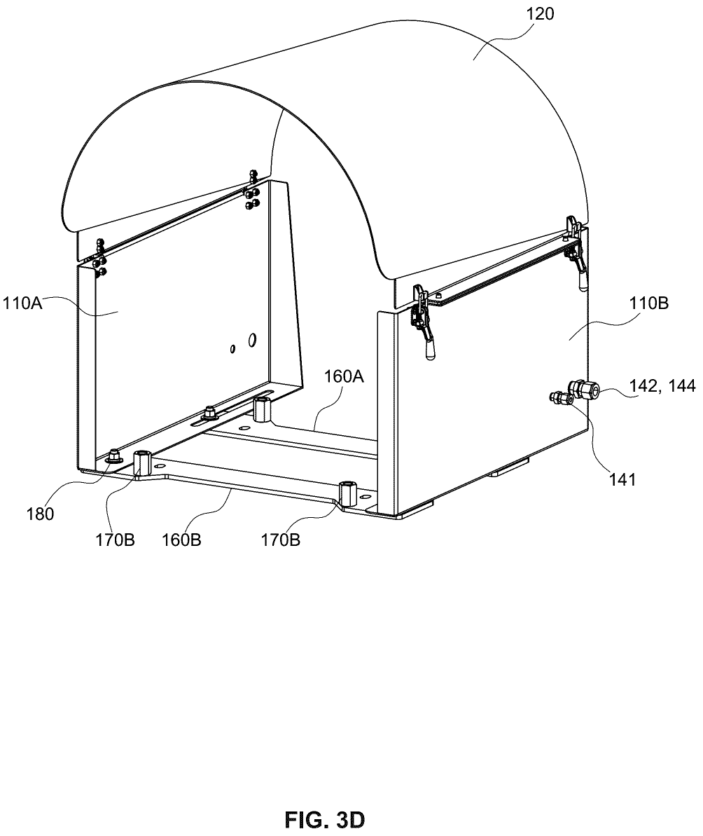

Referring now to FIGS. 3A, 3B, 3C, and 3D, by way of example, and not limitation, there is illustrated an example embodiment of housing, cover, cowling, guard, shroud, or isolation zone, such as outer housing 100. Outer housing 100 may include one or more vertical or upright side walls or panels 110, such as first outer housing side wall 110A and second outer housing side wall 110B. Outer housing 100 may further include angled, curved, or rounded top, such as first arching top 120 removably connected thereto first outer housing side wall 110A and second outer housing side wall 110B. Preferably, first outer housing side wall 110A and second outer housing side wall 110B may include angled or lipped edge, such as base edge 140 with first base edge 140A connected thereto first outer housing side wall 110A and second base edge 140B connected to second outer housing side wall 110B. It is contemplated herein that first outer housing side wall 110A and second outer housing side wall 110B may be removably affixed or attached thereto platform PL via first base edge 140A and second base edge 140B. Alternatively, first outer housing side wall 110A and second outer housing side wall 110B may include a base, such as platform PL (like platform PL in FIG. 1) connected thereto first outer housing side wall 110A and second outer housing side wall 110B via bolts 180. Moreover, base edge 140 with first base edge 140A and second base edge 140B may be connected by parallel base supports, such as first linear arm 160A and second linear arm 160B removably affixed on end points thereto first base edge 140A and second base edge 140B. Furthermore, first linear arm 160A and second linear arm 160B may include anchor posts 170, such as first anchor post 170A and second anchor post 170B utilized to removably affix outer housing 100 thereto base, such as platform PL (like platform PL in FIG. 1).

Still furthermore, arching top 120 may include a horizontal lip, such as edge flange 150 and more specifically first edge flange 151 and second edge flange 152 making up each edge of arching top 120. Moreover, first outer housing side wall 110A and second outer housing side wall 110B may include a horizontal lip, such as base edge flange 150 and more specifically third edge flange 153 and fourth edge flange 154 making up each upper edge of first outer housing side wall 110A and second outer housing side wall 110B. It is contemplated that the upper sidewalls and edges of the top, more specifically first edge flange 151 and second edge flange 152 making up each edge of arching top 120 and third edge flange 153 and fourth edge flange 154 of first outer housing side wall 110A and second outer housing side wall 110B may be removably affixed together to form outer housing 100 and support arching top 120 therebetween first outer housing side wall 110A and second outer housing side wall 110B. Alternatively, upper sidewalls and edges of the top, more specifically first edge flange 151 and second edge flange 152 making up each edge of arching top 120 and third edge flange 153 and fourth edge flange 154 of first outer housing side wall 110A and second outer housing side wall 110B may be releasably affixed together (clasped access) by an attachment device or latch mechanism, such as one or more clasp 190 and more specifically, first clasp 191, second clasp 192, third clasp 193, and fourth clasp 194.

It is contemplated herein that arching top 120 may be formed as a part of first outer housing side wall 110A and second outer housing side wall 110B to form outer housing 100.

Still furthermore, outer housing 100 and more specifically first outer housing side wall 110A and second outer housing side wall 110B may include one or more holes therethrough, such as apertures 160 configured as an instrument access or viewing port thereto first zone Z1, of for fire safety devices FS, such as fire detection device 141, fire suppression device 142, and temperature or fire sensing equipment 143, and foam injection nozzle 144 to connect via hosing or wires, such as fire safety tubing FST to fire protection, suppression, and sensing equipment, such as fire detection device 241, fire suppression device 242, and temperature or fire sensing equipment 243, and foam injection nozzle 244 and include a fire suppression agent system/nozzle arrangement and sensing line to provide fire containment and suppression capability therein inner housing 200, should a fire start in this area.

Moreover, outer housing 100 and more specifically first outer housing side wall 110A, second outer housing side wall 110B, and first arching top 120 may include one or more holes therethrough, such as outer housing aperture 160. More specifically, first outer housing side wall 110A may include one or more apertures 160 and second outer housing side wall 110B may include one or more apertures 160 configured to view inner housing 200 and one or more apertures 240 of FIGS. 2, to see therethrough to view motor-pump coupler C, mechanical seal assembly MSA, motor or pump shaft MS, PS, pump P positioned therein second zone Z2.

Furthermore, arching top 120 may include one or more hinge 195 hingedly connected therebetween arching top 120 and first outer housing side wall 110A or second outer housing side wall 110B to enable hinged access thereto first zone Z1 and inner housing 200. Still furthermore, first outer housing side wall 110A, second outer housing side wall 110B, and arching top 120 may include one or more edge cutouts, such as notch 320 configured to accommodate contour and shape differences between motor M, pump mechanical seal MSA, and pump P differences in dimensions, sizes, and configurations shown in FIG. 1 for the purpose of sealing first zone Z1 and directing forced air, such as cooling airflow CA from or through motor M and over mechanical seal assembly MSA to provide cooling air flow over mechanical seal assembly MSA.

Moreover, outer housing 100 and more specifically first outer housing side wall 110A, second outer housing side wall 110B, and first arching top 120 may include slanted or sloped surfaces sections, such as angled edge 130, and first angled edge 130A and second angled edge 130B to accommodate size and shape differences between motor M, motor-pump coupler C, pump mechanical seal MSA, and pump P, shown in FIG. 1. Moreover, outer housing 100 may be configured as a converging section but may be comprised of any shape suitable to direct air flow from motor M therethrough outer housing 100, which may include, but not be limited to, straight sections, conical section, or combinations of straight section and converging sections.

Outer housing 100 and inner housing 200 may be formed of any airtight, heat resistant, and/or corrosion resistant material, capable of creating a fire sealed area and directing airflow through a designated pathway. Moreover, outer housing 100 and inner housing 200 may preferably be constructed of stainless steel, aluminum, heat resistant fiberglass, plastic, as these materials offers a variety of forms and shapes; however, other suitable materials such as metal, concrete, composite, and the like, formed of multiple layers with different materials, or the like, may be utilized, provided such material has sufficient strength and/or durability as would meet the purpose described herein.

It is contemplated herein that outer housing 100 and inner housing 200 may be configured in other shapes other than a trough, such as angled, contoured, rectangle, tube, or channel.

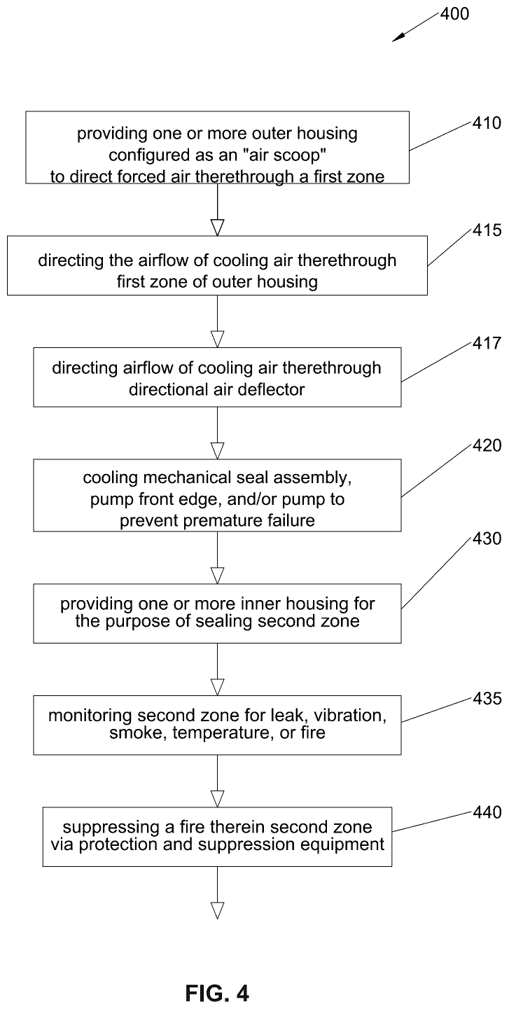

Referring now to FIG. 4, there is illustrated a flow diagram 400 of a method of use of pump guard 10. In block or step 410, providing one or more outer housing 100 configured as an “air scoop” to direct forced air, such as cooling airflow CA from or through motor M and over mechanical seal assembly MSA to provide cooling air flow over mechanical seal assembly MSA therethrough first zone Z1 (air cooling zone).

In block or step 415, directing the airflow of cooling airflow CA therethrough first zone Z1 of outer housing 100 and toward mechanical seal assembly MSA, pump front edge PFE, and/or pump P.

In block or step 417, directing the airflow of cooling airflow CA therethrough first zone Z1 and into directional air deflector 500 configured to scoop or capture cooling airflow CA from motor M traversing over first arching section 210 and redirect cooling airflow CA onto coupler C, mechanical seal assembly MSA, motor or pump shaft, mechanical seal assembly inner edge MSAIE, and/or front face of pump P to extend coupler C, mechanical seal assembly MSA, motor or pump shaft, mechanical seal assembly inner edge MSAIE, and/or front face of pump P life and to protect coupler C, mechanical seal assembly MSA, motor or pump shaft, mechanical seal assembly inner edge MSAIE, and/or front face of pump P from pre-mature failure by cooling these parts directly.

In block or step 420, cooling mechanical seal assembly MSA, pump front edge PFE, and/or pump P to provide the desired cooling effect for the mechanical seal assembly MSA to extend mechanical seal assembly MSA life and to protect mechanical seal assembly MSA from pre-mature failure.

In block or step 430, providing one or more inner housing 200 for the purpose of sealing second zone Z2 and to isolate rotating units of the motor M, pump-motor coupling, coupler C, mechanical seal assembly MSA, and/or pump P to limit access to rotating components and prevent spread of any fires from second zone Z2, and more specifically mechanical seal assembly MSA where a leak or fire may likely occur and for the purpose of fire protection, suppression, and sensing.

In block or step 435, monitoring second zone Z2 for leak, vibration, smoke, temperature, or fire therein via fire detection device 241, fire suppression device 242, and temperature or fire sensing equipment 243, and foam injection nozzle 244 and include a fire suppression agent system/nozzle arrangement and sensing line to provide fire suppression capability therein inner housing 200, should a fire start in this area and alarming if such detection is positive. It is recognized herein that arching top 120 of inner housing 200 may be equipped fire detection device 241, fire suppression device 242, and temperature or fire sensing equipment 243, and foam injection nozzle 244 and include a fire suppression agent system/nozzle arrangement and sensing line to provide fire containment and suppression capability therein inner housing 200 to provide fire suppression capability therein inner housing 200, should a fire start in this area.

In block or step 440, suppressing a fire therein second zone Z2 via fire detection device 241, fire suppression device 242, and temperature or fire sensing equipment 243, and foam injection nozzle 244 and include a fire suppression agent system/nozzle arrangement and sensing line to provide fire suppression capability therein inner housing 200 and suppression agent system/nozzle arrangement to provide fire containment and suppression capability therein inner housing 200, should a fire start in this area and isolating second zone Z2 from first zone Z1.

Concerning the description herein, it is to be realized that the optimum dimensional relationships, including variations in size, materials, shape, form, configuration, position, connection, function and manner of operation, assembly and use, are intended to be encompassed by the present disclosure.

It is further understood herein that the parts and elements of this disclosure may be located or positioned elsewhere based on one of ordinary skill in the art without deviating from the present disclosure.

With respect to the above description, it is to be realized that the optimum dimensional relationships, including variations in size, materials, shape, form, position, movement mechanisms, function and manner of operation, assembly and use, are intended to be encompassed by the present disclosure.

The foregoing description and drawings comprise illustrative embodiments. Regarding the described exemplary embodiments, it should be noted by those skilled in the art that the disclosures within are exemplary only, and that various other alternatives, adaptations, and modifications may be made within the scope of the present disclosure. Merely listing or numbering the steps of a method in a particular order does not constitute any limitation on the order of the steps of that method. Many modifications and other embodiments will come to mind for one skilled in the art this disclosure pertains to, having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. A shroud of a motor that generates a cooling airflow, a motor shaft, a motor-pump coupler, a, a pump shaft, (rotating units) mechanical seal assembly and a pump, the shroud comprising:
an outer housing configured as an air scoop having a first zone to direct cooling air from the motor over the pump mechanical seal assembly, the outer housing formed of a first outer housing side wall and a second outer housing side wall, and a first arching top connected thereto said first outer housing side wall and said second outer housing side wall;
an inner housing positioned within said outer housing and configured to seal a second zone therearound the motor shaft proximate the motor, the motor-pump coupler, and the mechanical seal assembly, said inner housing formed of a first arching section and a second arching section removably affixed together,
said first arching section having first upper end equipment seal to form an upper seal around the mechanical seal assembly of the pump and a second upper end equipment seal to form an upper seal around the motor shaft proximate the motor, and
said second arching section having first lower end equipment seal to form a lower seal around the mechanical seal assembly of the pump and a second lower end equipment seal to form a lower seal around the motor shaft proximate the motor.

2. The shroud of claim 1, said first arching section of said inner housing further comprising a directional air deflector positioned proximate a front edge and configured to direct the cooling airflow thereon the mechanical seal assembly.

3. The shroud of claim 1, further comprising an outer housing aperture configured to view said inner housing.

4. The shroud of claim 1, further comprising one or more hinge connected therebetween said first arching section and said second arching section to enable hinged access thereto said inner housing.

5. The shroud of claim 1, further comprising one or more clasp connected therebetween said first arching section and said second arching section to enable clasped access thereto said inner housing.

6. The shroud of claim 1, wherein said first arching top of said outer housing is configured slanted to accommodate height differences between the motor and the mechanical seal assembly.

7. The shroud of claim 5, said one or more clasp configured to releasably affix said first arching section and said second arching section.

8. The shroud of claim 1, wherein said inner housing is configured to the motor, the motor-pump coupler, and the mechanical seal assembly to prevent spread of any fires from a second zone thereunder the inner housing.

9. The shroud of claim 8, further comprising an aperture in said inner housing configured to view therein said second zone.

10. The shroud of claim 9, wherein said inner housing aperture further comprising an instrument access port.

11. The shroud of claim 10, wherein said instrument access port includes a fire suppression device.

12. The shroud of claim 11, wherein said fire suppression device includes a flame suppressant.

13. The shroud of claim 12, wherein said instrument access port includes fire sensing equipment.

14. The shroud of claim 1, further comprising one or more vertical supports to support said inner housing.

15. The shroud of claim 1, each said first arching section and said second arching section further comprising edge flanges, wherein said edge flanges may be utilized to join said first arching section to said second arching section.

16. A fire containment and cooling system, said system comprising:
a motor having a motor shaft;
a motor-pump coupler;
a mechanical seal assembly;
a pump having a pump shaft;
an outer housing configured as an air scoop having a first zone to direct cooling air from the motor over the pump mechanical seal assembly, the outer housing formed of a first outer housing side wall and a second outer housing side wall, and a first arching top connected thereto said first outer housing side wall and said second outer housing side wall;
an inner housing positioned within said outer housing and configured to seal a second zone therearound the motor shaft proximate the motor, the motor-pump coupler, and the mechanical seal assembly, said inner housing formed of a first arching section and a second arching section removably affixed together,
said first arching section having first upper end equipment seal to form an upper seal around the mechanical seal assembly of the pump and a second upper end equipment seal to form an upper seal around the motor shaft proximate the motor, and
said second arching section having first lower end equipment seal to form a lower seal around the mechanical seal assembly of the pump and a second lower end equipment seal to form a lower seal around the motor shaft proximate the motor.

17. The fire containment and cooling system of claim 16, wherein said inner housing are configured to isolate said motor, said motor-pump coupler, and said mechanical seal assembly to prevent spread of any fires from said inner housing.

18. The fire containment and cooling system of claim 17, further comprising an inner housing aperture configured to view therein said inner housing.

19. The fire containment and cooling apparatus of claim 18, wherein said inner housing aperture further comprising an instrument access port.

20. The fire containment and cooling system of claim 19, wherein said instrument access port includes a fire suppression device.

21. The fire containment and cooling system of claim 20, wherein said fire suppression device includes a foam injection nozzle.

22. The fire containment and cooling system of claim 20, wherein said instrument access port includes fire sensing equipment.

23. The shroud of claim 1, wherein said inner housing is configured to capture a leaked fluid being slung by centrifugal force of the rotating units.
